(19) United States
(12) Patent Application Publication
(10) Pub. No.: US 2002/0019978 A1
(43) Pub. Date: Feb. 14, 2002

(54) Video enhanced electronic commerce systems and methods

(76) Inventor: Michael S. Terretta, New Canaan, CT (US)

Correspondence Address: Basam E. Nabulsi, 113 Charter Oak Drive, Wilton, CT, 06897, US

(21) Appl. No.: 09/817,080

(22) Filed: Mar. 26, 2001

Related U.S. Application Data
(60) Provisional application No. 60/211,310, filed on Jun. 13, 2000.

(51) Int. Cl. H04N 7/025

(52) U.S. Cl. 725/34; 725/35

(57) ABSTRACT

A system and method for enhancing electronic commerce and/or communicating information concerning products and/or services in connection with multimedia (e.g., video) transmission and delivery is provided. The system and method facilitate targeted marketing and/or merchandising in connection with video streams delivered to users across a computer network, e.g., the Internet and/or the World Wide Web, by synchronizing ancillary content with the video stream. User database(s) and commerce database(s) are provided for real time determination of ancillary information to be displayed for individual users of the system. A list block may be utilized by an individual user to capture ancillary content that is displayed with the video stream for his/her subsequent attention, e.g., as a navigation bar. The method/system may be used in a broad range of applications for live, taped live and on-demand video streams.

### CROSS REFERENCE TO RELATED APPLICATIONS

The present application claims the benefit of a commonly assigned, co-pending provisional patent application entitled “Video Enhanced Electronic Commerce Systems and Methods,” filed on June 13, 2000 and assigned Serial No. 60/211,310, the contents of which are hereby incorporated by reference in their entirety.

### BACKGROUND

1. Technical Field

The present disclosure relates to a system and method for enhancing electronic commerce and/or communicating information concerning products and/or services in connection with multimedia (e.g., video) transmission and delivery. More particularly, the present disclosure relates to a system and method that facilitates targeted marketing and/or merchandising in connection with video streams delivered to users across a computer network, e.g., the Internet and/or the World Wide Web.

2. Background of the Related Art

Data communications across the Internet were initially text-only media. While the Internet, and particularly the World Wide Web, continues to service significant text-only transmissions, increasingly users of and content providers to the Web are focused on multimedia transmissions. Accommodating multinedia transmissions across the Internet implicates significant technical issues because of the huge amounts of data required to allow users to access and enjoy graphics, audio and/or video content. Accommodating these large data requirements is more easily addressed in the personal computer environment than in the networked world of the Internet. Successfully addressing the transmission of large data requirements across the Internet will allow an individual's personal computer to become a universal source of information and communication, operating as the functional equivalent of a television, radio, stereo and telephone.

Significant issues associated with multimedia transmissions across the Internet involve bandwidth and latency. A user's ability to receive the requisite amounts of data is dependent upon the amounts of data than can be transmitted across a network, a computer bus, and/or any of the other data pathways that are involved in data transmission. Bandwidth on the Internet is being increased at a rapid pace through improved technologies, including the movement toward cable and DSL (digital subscriber line) connections. Moreover, streaming technologies and protocols have been developed in an attempt to address the relatively narrow bandwidth available for multimedia transmissions, e.g., through traditional modem connections.

Streaming enables a personal computer, personal digital assistant (PDA), set top box, and the like (collectively referred to as a “PC”) to play a multimedia file as soon as the first bytes arrive at the PC, rather than requiring the personal computer to await downloading of the entire multimedia file. According to conventional streaming technology, multimedia files are transmitted using a “user datagram protocol” (UDP) rather than the “transmission control protocol” (TCP) associated with most Internet transmissions. A crucial difference between the two protocols is how they check for transmission errors. In the case of TCP protocol, the mistransmission of a packet of information across the Internet generally results in suspension of the transmission while a retransmission of the erroneous packet of data is requested and received. By contrast, the UDP protocol generally permits periodic mistransmissions of data packets without interrupting the transmission flow. The UDP protocol recognizes that, in receiving and processing multimedia transmissions, periodic missed or erroneous frames or data packets will not have a meaningfully adverse effect on the quality of the transmission. Indeed, the user may not notice the error in processing the transmission.

In general, streaming audio files across the Internet begins with a user clicking on a link to an audio source. In response, the Web browser contacts the Web server holding the current Web page. The server sends the user's browser a small file generally called a “metafile.” The metafile indicates where the user's browser can find the sound file. The sound file may be located on a multiplicity of possible servers, i.e., it need not be located on the Web server initially contacted by the browser. In addition, the metafile contains information on how to play the audio file. Generally, the metafile directs a user's browser to a load balancer that assesses the optimal server among an array of servers to deliver the audio file to the user.

The metafile instructs the Web browser to launch the appropriate audio player. Audio players are generally plug-ins, i.e., mini-programs designed to work with a particular browser such as Netscape Navigator or Microsoft Internet Explorer. The audio player communicates with the audio server that will provide the sound file, and provides relevant information to the audio server, e.g., how fast the Internet connection is to the user's PC. Based on the speed of the connection, the audio server generally selects one of several versions of the audio file for transmission to the user. The audio server generally transmits higher quality sound, which requires greater bandwidth, over faster links, and lower quality sound over slower connections. The audio server transmits the audio file, via the Internet's network of servers, to the user's PC through a series of packets in user datagram protocol (UDP). Each step through the Internet's network of servers may be termed a “hop” and potentially impedes, slows and/or degrades the data transmission passing therethrough.

When the data packets arrive at the user's PC, the system decompresses and decodes the data, sending the decoded results to a buffer, i.e., a small portion of the PC's RAM that holds a few seconds of sound. When the buffer fills up, the audio player starts to process the file through its sound card, turning the file data into voices, music and/or sounds, while the audio server continues to transmit additional aspects of the audio file through the Internet's network of servers. This transmission modality can continue indefinitely. In the event the buffer is temporarily depleted of data, e.g., if the user accesses a different Web page, if the connection is poor, or if Internet traffic is high, thereby interfering with data transmission, the audio replay will cease. Once the buffer again accumulates sufficient data, the audio replay will resume. In the event the source of the audio data is a “live” performance, depletion of the buffer will cause the audio player to, in effect, skip portions of the performance, whereas if the source of the audio data is prerecorded, the audio replay will generally pick up where it left off.

Conventional video streaming operates in a comparable manner. Generally, a server includes a video capture expansion card that receives ordinary analog video signal from a source, either “live” feed or recorded tape, and converts the analog signal into digital information, e.g., at a rate of thirty frames per second. The video capture card typically transmits the digital information through a “codec” or compression/decompression algorithm to facilitate communication across the Internet. Interframe compression allows the server to compare adjacent frames and to transmit only those pixels that change from one frame to the next. For example, when the camera is still, the background is not transmitted after a key frame that established the background appearance. Conversely, when the camera pans, causing the background to change, the entire frame is transmitted, thereby creating a superceding key frame. Through interframe compression, less data is transmitted across the Internet when a camera is still or other aspects of the visual image remain unchanged. In addition to interframe compression, codecs typically skip frames to accommodate slower Internet links. Thus, the faster the Internet connection, the more frames that are transmitted to the user's PC and the smoother the video replay appears to the user.

The video server generally breaks up the compressed video data into one of two types of packets, based on the transmission protocol to be utilized. According to a first transmission protocol, IP (Internet provider) multicast packets are transmitted as a single signal to a computer acting as a multicast server. On a relative basis, the IP multicast uses less bandwidth than the alternative and more prevalent protocol, namely UDP. The multicast server duplicates the video signal received from the video server and transmits the duplicated signal to all requesting client PCs. By contrast, when using the user datagram protocol, no special network hardware, e.g., a multicast server, is required. Rather, UDP packets are sent to every client PC from the video server, thereby necessitating greater bandwidth. However, the UDP packets are generally more efficient in preventing gaps or pauses in the audio portion of the signal.

Upon receipt of the multimedia transmission, each PC decompresses the video and loads the data into a RAM buffer. From the buffer, the signal is split into video and audio components that are forwarded to the video and sound cards, respectively. As with pure audio streaming, video streams simply skip packets that cannot be processed in real time. However, unlike audio processing, a corrupted video packet can cause a defect that carries over to subsequent frames. To address this potential, the PC generally compares new frames with prior frames to detect errors and correct them by using visual information from an uncorrupted frame.

From a topological standpoint, several systems have been developed for delivery of multimedia signals through a network of servers, e.g., across the Internet and/or the World Wide Web, including a proprietary network topology utilizing “metaswitch” technology developed by the assignee of the present application. Such delivery systems are described in a commonly assigned patent application entitled “Network Communication System Including Metaswitch Functionality,” filed with the U.S. Pat. No. and Trademark Office on Feb. 12, 2001 and assigned Ser. No. 09/781,379, the contents of which is hereby incorporated by reference in its entirety. Such delivery systems generally facilitate data transfer and communication, particularly streaming of multimedia data (e.g., graphics, audio and/or video files).

Despite the continued evolution and improvements associated with multimedia streaming technologies, several significant needs remain. For example, it is desirable to permit entities involved in producing and/or sponsoring multimedia transmissions, e.g., video streaming, to target their merchandising and/or marketing efforts based on the content of such multimedia transmissions. It is further desirable to target merchandising and/or marketing efforts associated with multimedia transmissions based on demographic and/or personal preference data associated with the recipients of such multimedia transmissions. These and other objectives are advantageously achieved through methods and systems disclosed herein.

### SUMMARY OF THE DISCLOSURE

A system and method for enhancing electronic commerce and/or communicating information concerning products and/or services in connection with multimedia (e.g., video) transmission and delivery is provided. The system and method facilitate targeted marketing and/or merchandising in connection with video streams delivered to users across a computer network, e.g., the Internet and/or the World Wide Web, by synchronizing ancillary content with the video stream. User database(s) and commerce database(s) are provided for real time determination of ancillary information to be displayed for individual users of the system. A list block may be utilized by an individual user to capture ancillary content that is displayed with the video stream for his/her subsequent attention, e.g., as a navigation bar. The method/system may be used in a broad range of applications for live, taped live and on-demand video streams.

In a preferred embodiment of the present disclosure, a system for delivering content to a user is provided. The system includes encoder(s) for receiving and encoding a multimedia file, e.g., a video stream or the like. The system also includes a synchronization system that communicates with the encoder and is adapted to synchronize ancillary information with the multimedia file. The ancillary information may take many forms, e.g., goods, services, background information and the like.

A display unit is typically utilized by the user to display the encoded multimedia file, e.g., across the Internet, World Wide Web or other computer network. Upon linking to the multimedia file, e.g., using a conventional browser, the disclosed system advantageously provides a personalization technology that permits an individual user to receive ancillary information of particular interest to that user. For example, the personalization technology may utilize the ancillary information to select ancillary content for display in synchronization with the encoded multimedia file, e.g., from among available choices contained within a commerce database.

The present disclosure also advantageously provides a method for facilitating targeted communication with individual users. The method includes providing an encoded multimedia file to the user that includes multimedia content and synchronized ancillary information. Based on the synchronized ancillary information, the disclosed method selects ancillary content from a commerce database for viewing by the individual user. For example, based on the ancillary information, a selection is made based at least in part upon personal information concerning the individual user. The personal information is advantageously contained within a user database associated with the method/system of the present disclosure.

Further detailed information concerning the method/system of the present disclosure will be apparent from the detailed description, accompanying figures and claims that follow.

### BRIEF DESCRIPTION OF THE FIGURES

To facilitate a full and complete understanding of the disclosure herein, reference is made to the attached figures and accompanying description, in which:

FIG. 1 is a schematic depiction of a system/method according to the present disclosure; and

FIG. 2 is a schematic depiction of an alternative system/method according to the present disclosure.

### DETAILED DESCRIPTION OF PREFERRED EMBODIMENT(S)

According to the present disclosure, systems and methods are described for advantageously enhancing electronic commerce and/or communicating information concerning products and/or services in connection with multimedia (e.g., video) transmission and delivery. More particularly, the present disclosure provides a system/method that facilitates targeted marketing and/or merchandising in connection with video streams delivered to users across a computer network, e.g., the Internet and/or the World Wide Web.

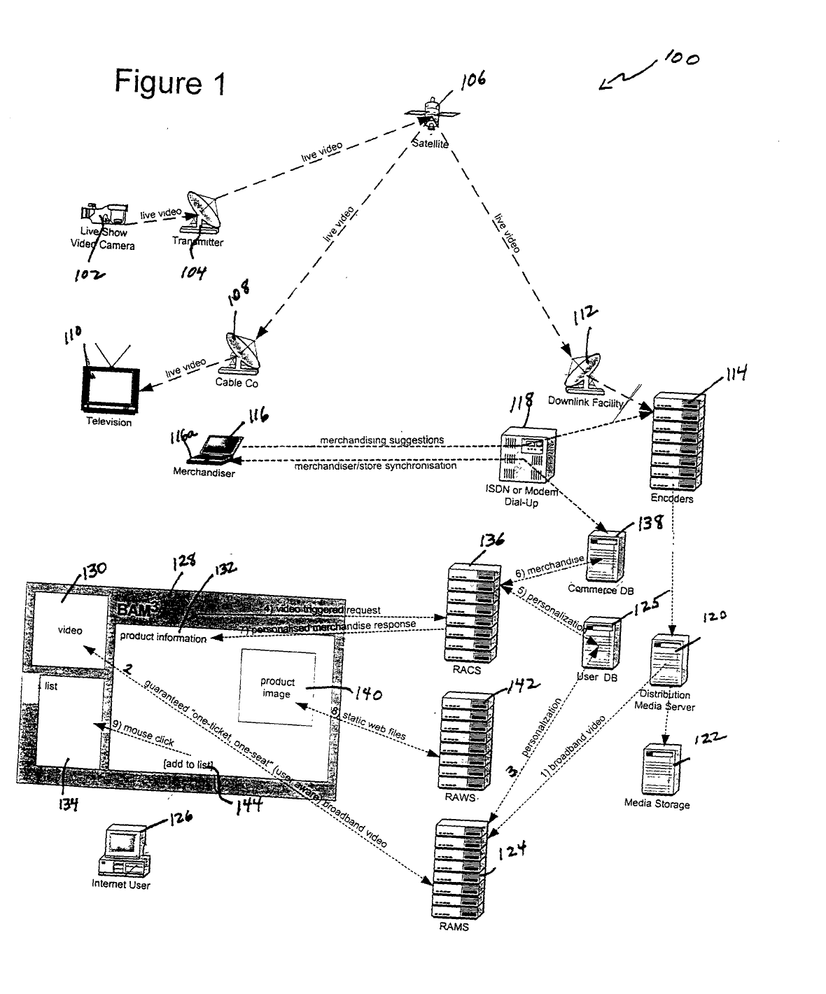

Referring to FIG. 1, an exemplary system 100 according to the present disclosure is depicted. Delivery of multimedia transmission(s) to a user according to system 100 involves the capture of video images using conventional filming technology, e.g., video camera 102. Video camera 102 may be used to capture video and associated audio in connection with the creation of desired programming. Multiple cameras may be used to collect footage related to a production and direction/production based on such multiple footage feeds may be undertaken utilizing conventional production technology. As noted in FIG. 1, a show or event may be filmed by a live production crew. The crew may be a conventional television crew, on location, or a crew specially trained with respect to the advantageous system/method disclosed herein.

The video/audio feed is generally uplinked or uploaded to satellite(s) 106 by conventional transmitter(s) 104. The uploaded transmission may be a “post production” live show, or may consist of raw camera feeds that may be utilized downstream, e.g., by an Internet/World Wide Web user and/or a post-satellite production facility, to create a multimedia production. Technology for transmitting data to and from satellites is well known to those of skill in the art. The system/method of the present disclosure does not require any modifications and/or refinements to such conventional technology, and may be easily adapted for use with future transmission technologies as may become available from time to time. Moreover, the system/method of the present disclosure contemplates transmission of the video/audio feed independent of satellite transmission, i.e., by utilizing terrestrial connectivity, e.g., fixed T1 and/or T3 lines or the like, and combinations thereof.

Of note, the multimedia transmission uploaded to satellite(s) 106 may be downliked or downloaded to receiver(s) 108 for multimedia distribution facilities, e.g., a cable or direct satellite delivery service. Alternatively, the multimedia transmission may be transmitted to desired multimedia distribution facilities using terrestrial connectivity. In either case, the “live” video stream captured by camera(s) 102 may be delivered to television(s) 110 in “real-time.” As delivered to television(s) 110 according to the depicted system in FIG. 1, no changes to conventional technology are contemplated. However, as illustrated by the exemplary schematic depiction of FIG. 1, system 100 does not interfere with conventional multimedia distribution channels. Rather, the system/method of the present disclosure advantageously augments conventional multimedia delivery systems while providing significantly improved functionality and targeted merchandising/marketing/promotion/communication, as described in greater detail hereinbelow.

Returning to FIG. 1, the multimedia transmission may be advantageously downlinked or downloaded (or otherwise transmitted) to receiver(s) 112 associated with proprietary aspects of the method/system of the present disclosure. Preferably, the feed coordinates for satellite(s) 106 are provided to an operator of the advantageous system/method to facilitate downlinkig/downloading of such multimedia transmission. Receiver(s) 112 may be physically located at the same site as the hardware systems described hereinafter, or may be remotely located relative thereto. In either case, appropriate network communication technology is provided to facilitate data exchange and communication between receiver(s) 112 and the associated hardware systems, as described herein.

The multimedia transmission stream is directed to one or more encoders, e.g., a bank of encoders 114. Simultaneously, the multimedia stream is viewed by an individual, e.g., on a computer monitor 116. The individual determines products and/or services, preferably product and/or service categories, that may have particular interest to individual(s) who will be viewing the multimedia transmission based on the content and/or context of the multimedia transmission. For example, if the multimedia transmission involves the Chief Operating Officer describing his/her company's new product offerings, the individual viewing the multimedia transmission at monitor 116 may determine that those new product offerings would be of particular interest to future viewers thereof Similarly, if the multimedia transmission involves a fashion show, the individual at monitor 116 may determine that the dresses, shoes and/or accessories being worn by a model at a given point in time might be of interest to viewers. In like manner, if the multimedia transmission involves broadcast of a sporting event, the individual at monitor 116 may determine that information concerning future games involving the teams, player memorabilia, books authored by or about players, archival video clips involving the teams/players, and/or team souvenirs might be of interest to viewers. Potential examples of and applications for context-based micro-marketing, merchandising and management (or, more generally, context-based communication) in connection with multimedia delivery of broadband content to viewers are boundless.

The individual at monitor 116 may be physically located at any location, provided he/she is able to view the multimedia transmission in real-time. Thus, monitor 116 may be operated at the location where the multimedia content is being filmed and/or produced, e.g., the same physical location as video camera(s) 102, or at any remote location having real-time access to the multimedia stream The individual at monitor 116 preferably inputs product and/or service categories (or other contextually relevant information) having relevance to the multimedia transmission at a particular point in time, e.g., using a keyboard 116a associated with monitor 116. Such input is transmitted to encoder(s) 114, e.g. by way of an ISDN or modem dial-up unit 118. Encoder(s) 114 combine the context-based input with the multimedia transmission, thereby directly associating the context-based input with the multimedia transmission for future use and access by viewers. As the multimedia transmission continues to stream into encoder(s) 114 and is simultaneously viewed by an individual at monitor 116, additional contextbased input is transmitted to encoder(s) 114 for combination with the multimedia stream. Accordingly, the creation of a multimedia transmission stream that includes context-12 based input for viewing by future viewers is typically a continuous process, whereby the context-based input advantageously varies over time based upon the real-time content of the multimedia transmission.

In a preferred embodiment of the present disclosure, the multimedia transmission stream is encoded for playback using Windows Media Player (Microsoft Corporation, Redmond, Wash.) by encoder(s) 114, e.g., by encoding into Advanced Streaming Format (.asf). Windows Media Player advantageously facilitates synchronized multimedia transmission, e.g., coordination of events between a Windows Media Player and a Web browser. Synchronization on the Windows Media Player platform may be achieved in several ways, as are known in the art, e.g., using HTML+TIME (timed interactive multimedia extensions), and/or by embedding Windows Media Player into a Web page and utilizing functionality built into the Advanced Streaming Format and Windows Media Player. Further information on effectuating synchronized multimedia delivery on the Windows Media Player platform may be obtained with reference to “Inside Windows Media™,” Microsoft Corporation, the contents of which are hereby incorporated by reference in its entirety.

From the encoder(s) 114, the multimedia stream that now includes context-based input is fed to a distribution media server that advantageously directs the stream to both a media storage unit 122 and a redundant array of media servers (“RAMS”) 124. The media storage unit 122 advantageously stores the multimedia stream for future access and use, e.g., for “on demand” viewing by users. Delivery of the multimedia stream to RAMS 124 generally constitutes broadband video delivery thereto. RAMS 124 typically comprises a parallel array of individual media servers.

With further reference to FIG. 1, a viewer/user who elects to view the multimedia transmission that has been fed through encoder(s) 114, whether in real time from RAMS 124 or on-demand from media storage unit 122, accesses the multimedia transmission according to conventional access modalities. Thus, if the viewer/user has access to such multimedia transmissions by reason of a subscription service or based on a pay-per-view/authenticated viewing purchase, appropriate log-in/password clearance procedures are undertaken, as is well known in the art. The multimedia transmission is advantageously accessed by a viewer/user over a networked system, e.g., via the Internet and/or the World Wide Web, for viewing at his/her personal computer, set-top box and/or PDA 126. Alternative delivery systems are contemplated, e.g., more localized network systems such as LANs and/or WANs.

In an embodiment of the system/method of the present disclosure wherein a pay-per-view/authenticated viewing or other subscription system is in use, it is desirable to utilize a system for ensuring that a user/registrant is not able to access multiple streams of content using a single user account by determining whether the user's account is already receiving content from RAMS 124 when each new request for multimedia content is received. In addition, an automatic sign-up wizard may be advantageously employed that automatically checks a potential user's creditworthiness and/or ensures that user database 125 is current with new/updated information concerning such user. In connection with the aforementioned advantageous systems, a commonly assigned provisional patent application entitled “Improved System for Providing Pay-Per-View Programing,” filed on Mar. 27, 2000 and assigned Ser. No. 60/192,166, describes a preferred authentication system/method according to the present disclosure, and is hereby incorporated herein by reference.

Personalized and/or demographic information concerning viewers/users of a system/method according to the present disclosure is advantageously collected and known for use in customizing the targeted merchandising suggestions or other communications delivered to each such viewer/user herein. Thus, a user database 125 is advantageously maintained wherein individualized data concerning viewers/users is collected, maintained and subsequently accessed as described below. Typical user information/data may include age, gender, income level, prior purchases of products/services, prior multimedia transmissions viewed according to the present disclosure, etc. User database 125 may also advantageously include password/validation information for providing access to viewers/users according to the present disclosure. User database 125 is preferably updated on a continuous basis to reflect current viewer/user data and purchasing/viewing behavior.

As schematically depicted in FIG. 1, an exemplary screen display 128 for viewer/user at computer 126 may advantageously include three principal content blocks 130, 132, 134. Video block 130 advantageously allows the viewer/user to view the images associated with the multimedia transmission, e.g., in “real-time” from RAMS 124. As the multimedia transmission is received by the viewer/user at computer 126, a request or inquiry is automatically transmitted in response to each context-based input encountered in connection with the multimedia transmission. For example, as the multimedia transmission reaches the point where the hypothetical CEO mentioned hereinabove is describing a new software product for organizing/monitoring/managing an individual's health fitness, a request/inquiry is transmitted across the network by which the multimedia transmission reached the viewer/user, e.g., the Internet or the World Wide Web, to deliver the context-based input called for by the encoded multimedia transmission stream Thus, the encoded multimedia transmission contains a trigger for accessing appropriate information for display at exemplary screen 128 in real-time, e.g., based upon HTML+TIME synchronization technology.

The request/inquiry from computer 126 is typically directed to a parallel redundant array of commerce servers (“RACS”) 136. RACS 136 responds to the request/inquiry, providing product/service information or other content for display in product information block 132 on exemplary screen display 128. RACS 136 determines the content to be displayed in product information block 132 based on several factors. First, RACS 136 advantageously communicates with user database 125 to determine relevant characteristics of the current viewer/user for purposes of the context-based input that has triggered the request/inquiry. Thus, for purposes of the hypothetical software product described above, the context-based input may call for display of health fitness products/services or health fitness clothing or books about health fitness, etc. The determination of what category or class of products/services to display at this point in the multimedia transmission was made by the individual viewing the multimedia transmission at monitor 116, and is reflected in the encoded information giving rise to the triggered inquiry/request.

For purposes of the present hypothetical illustration, it is assumed that the context-based encoded information calls for display of health fitness clothing. In response to this encoded category of products (as opposed to a specific product, e.g., blue Nike sweat pants), RACS 136 queries user database 125 for relevant information about the viewer/user. For example, user database 125 may contain information concerning the viewer/user that he/she is a mid-thirties individual who actively and routinely purchases products over the Internet. User database 125 may also contain information concerning the viewer's preferred retail outlets, e.g., Amazon or Wal-Mart, and/or information concerning the viewer's financial position, e.g., approximate annual income. Based on this personalized information, if any, RACS 136 selects a product/service from among those that fall within the encoded category (health fitness clothing) for display on product information block 132.

It is further contemplated that alternative criteria/parameters may be employed to control and/or influence selection of an appropriate product/service for display in information block 132. For example, market research criteria/parameters may influence the selection of a product/service, e.g., based on an advertiser's desire to test the relative effectiveness of multiple HTML—based product presentations among certain demographic groups. Similarly, geography, time of day, time of year, and the like may influence the selection process, preferably in combination with information specific to the viewer/user accessing the multimedia content.

For purposes of the current hypothetical example involving health fitness, it is assumed that RACS 136 determines that an appropriate product for display is a warm-up suit in the lower price range, e.g., a product typically offered by Wal-Mart as opposed to Macys. RACS 136 communicates with a comnerce database 138 to access relevant information about wam-up suits. The commerce database 138 advantageously contains up-to-the-minute information concerning products/services for use in response to encoded context-based merchandising suggestions. Products/services included in commerce database 138 may be limited to participating product/service sponsors of the method/system of the present disclosure and/or products/services offered by retail outlets who are participating sponsors thereof. Commerce database 138 is preferably updated by sponsors on a periodic basis to reflect current product/service offerings, pricing, etc.

Returning to FIG. 1, RACS 136 determines from commerce database 138 an appropriate product/service for display in product information block 132, taking into consideration personalized information concerning the viewer/user contained within user database 125. For example, based upon the viewer's frequent visits to baseball-related Internet sites, RACS 136 may determine to display a warm-up suit available at Wal-Mart's online site that includes 100% cotton sweatpants and a matching sweatshirt that features the NY Yankees logo. Relevant information concerning the warm-up suit is automatically written into the HTML for rendering of product information block 132 on exemplary display screen 128. The functionality of RACS 136 is performed rapidly, such that the customized HTML is received at computer 128 substantially simultaneously with hypothetical CEO's discussion of his health fitness-related software product. Information displayed in product information block 132 may advantageously include general information concerning the selected warm-up suit, e.g., available colors, sizes, pricing, alternative logos, retail outlets carring the product, etc.

In a preferred embodiment of the method/system of the present disclosure, the HTML for rendering product information block 132 includes a link to a static image of a promotional image associated with the product/service, e.g., the catalog photograph associated with the warm-up suit described hereinabove. In such case, computer 126 forwards a query/request to a redundant array of web servers (“RAMS”) 142 to retrieve the referenced image. The retrieved image, e.g., a catalog picture of the warm-up suit, is advantageously displayed on exemplary screen display 128, e.g., as an inset box 140 adjacent product information contained within product information block 132.

Upon viewing the personalized product/service information in product information block 132 (and inset box 140), a viewer/user may determine that he/she has preliminary interest in further evaluating the featured product/service. According to the method/system of the present disclosure, a viewer/user may advantageously enter an identification of and associated link to the product/service in a list block 134 on the exemplary screen view 128. The viewer/user generally adds a featured product/service to list block 134 by clicking on a screen-featured command, e.g., an “Add to List” command 144 located at the bottom of exemplary screen display 128. Of note, list block 134 is typically not a “shopping cart,” as that term has come to be known in the art. Indeed, information required to complete a purchase, e.g., size, color, quantity, etc., is typically not solicited or obtained from or by a viewer/user at exemplary screen display 128. Rather, list block 134 provides an advantageous navigational shopping tool for subsequent use by the viewer. In a preferred embodiment according to the present disclosure, list block 134 becomes a featured navigational tool for the viewer/user as he/she visits retail sites, e.g., on the Internet/World Wide Web, from which the product/service may be acquired.

As a multimedia communication continues to be viewed by a viewer/user at computer 126, additional encoded context-driven merchandising information or other communications will be encountered. In each such instance, an inquiry/request will be transmitted to RACS 136 which, in turn, will result in a query to user database 125 for relevant personalized information concerning the viewer/user and a query to commerce database 138 for relevant information concerning a product/service or other information responsive to the context-based input. The viewer will therefore see a sequence of products/services or other information in product information block 132 (and inset box 140) that relate to or are otherwise deemed relevant to the content of the multimedia communication. Based upon the success/failure of various encoded merchandising suggestions or other communications, e.g., the degree to which context-based input results in additions to the list block 134 and/or purchases of products/services by the viewer, an individual responsible for inputting the context-based merchandising information to encoder(s) 114 may adjust his/her approach. Similarly, programming may be provided that optimizes the offerings featured by RACS 136 based upon past successes/failures of merchandising features in product information block 132. Indeed, the system/method of the present disclosure provides a powerful tool for testing, analyzing and improving upon marketing and merchandising themes, techniques and communications, both in general and among specifically demarcated user groups.

Even though a single multimedia communication is being processed through encoder(s) 114 and a single context-based input is being transmitted to encoder(s) 114 by the individual viewing the multimedia communication at monitor 116, e.g., using HTML+TIME synchronization technology, each viewer's experience at computer(s) 126 may be different. Based upon personalized information contained within user database 125 for individual viewers/users and/or randomization at RACS 136, different products/services may be featured in product information block 132 for different viewers/users. In preferred embodiments of the method/system of the present disclosure, viewers/users are able to effectively guide the merchandising selections provided for his/her consideration by providing relevant preferences to user database 125, thereby permitting the system/method of the present disclosure to make optimized merchandising selections for such individuals.

Of note, commerce database 138 preferably automatically transmits information to the computer associated with monitor 116 concerning updated product/service offerings contained therewithin. Such updated information facilitates context-based input by the individual viewing the multimedia communication in real time at monitor 116 to more effectively merchandize such products and services. Commerce database 138 typically transmits such updated information across a network, e.g., the Internet or World Wide Web, and delivers such updated information to the computer associated with monitor 116, e.g., via ISDN or modem dial-up unit 118.

The content featured in product information block 132 need not be limited to products/services for purchase. Indeed, the system/method of the present disclosure has widespread application for enhanced media delivery. Thus, for example, a viewer/user who is viewing an entertainment event in video block 130, e.g., a sporting event, concert, movie, play, etc., may benefit from ancillary content displayed in product information block 132. Such ancillary content may include background information concerning performers and/or participants, back-stage images, archival and historical clips, etc. A viewer/user may wish to revisit this ancillary content and, to the extent the ancillary content displayed in product information block 132 was incomplete, potentially view such ancillary content in its entirety. The viewer/user can easily retain a link to this ancillary content by clicking the “Add to List” trigger on exemplary screen display 128, thereby adding the ancillary content link to list block 134. At a future point in time, list block 134 may be utilized by the viewer/user as a navigational tool to access ancillary content of interest. In the event such ancillary content has been processed according to the present disclosure, e.g., is contained within media storage unit 122 after encoding by encoder(s) 114, additional merchandising and/or ancillary content may be featured in product information block 132 as such ancillary content is viewed.

In further examples of the benefits associated with the system/method of the present disclosure, ancillary content may be advantageously associated with distance learning and/or corporate communication multimedia transmissions over a network, e.g., over the Internet or the World Wide Web. Thus, a professor's presentation may be augmented by ancillary materials relevant to his/her lecture, e.g., using HTML+TIME synchronization technology, and based upon information concerning individual viewers/users contained in the user database, individual viewers/users may advantageously receive different ancillary content. For example, a physics lecture may beneficially offer advanced ancillary materials to students majoring in math, and less advanced ancillary materials to political science majors. In the case of corporate communications, an internal financial presentation to employees of Corporation X may offer ancillary materials that provide senior management with detailed financial reports, but limit less senior employees to less detailed financial information. Again, the appropriate level of information to be provided to individuals viewing the corporate communication may be determined in real time, based on information concerning the viewers/users contained in user database 125.

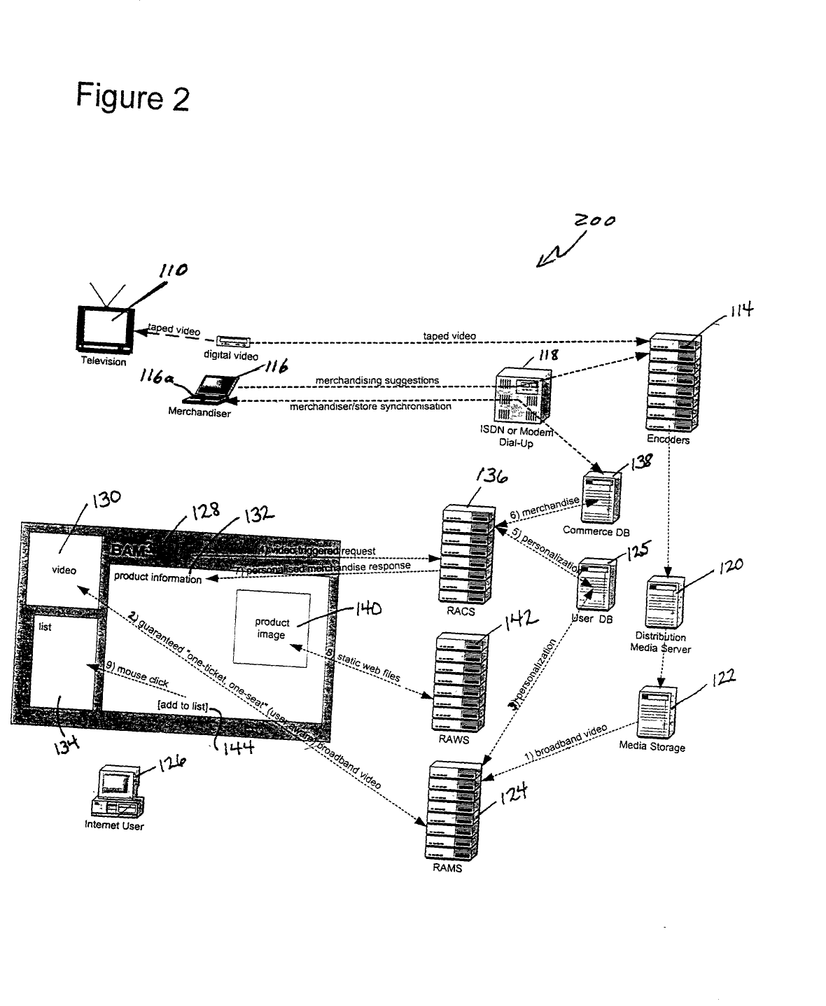

Turning to FIG. 2, an alternative system 200 according to the present disclosure is depicted in which elements that are the same as or similar to those described with reference to system 100 in FIG. 1 are identified with the same designations. System 200 depicts an application of the method/system of the present disclosure wherein a multimedia communication, e.g., a video transmission, is viewed at a point in time subsequent to its creation and/or filming. For example, system 200 contemplates situations where a show or other multimedia content may be distributed directly to viewers on the Internet, the World Wide Web or some other computer-based network from “tape” (or some other storage medium) as the tape is played for the first time. In television parlance, such delivery is referred to as a “taped live” broadcast. System 200 further contemplates viewing by a user “on-demand” at such user's convenience, in which case the show or other multimedia content may be stored for later viewing by individuals on an individual basis.

A potential problem with stored content for subsequent viewing by users, whether in a “taped live” or “on-demand” scenario, is that products/services/ancillary content to be merchandised or otherwise made available to users may have been modified, discontinued, etc. To the extent promotional/marketing offers were stored directly with the stored content, e.g., encoded with the stored content, viewers/users would potentially receive obsolete or inaccurate information.

This potential problem is obviated according to the system/method of the present disclosure because the encoding of merchandising and/or ancillary content information is generally “category” based, rather than specific product/service based. Thus, the encoded multimedia communication contained within media storage unit 122 is automatically updated to reflect current product/service/ancillary content because RACS 136 retrieves current information/content from commerce database 138 encompassed within an encoded “category” associated with the multimedia communication. Thus, the system/method of the present disclosure does not run the risk of providing inaccurate/obsolete information, provided the information contained within commerce database 138 is current and accurate. The real-time retrieval of product/service/ancillary content from commerce database 138 by system 200 ensures that shows/multimedia communications contained within media storage unit 122 are provided to users/viewers in exemplary screen display 128 with current merchandising/ancillary content within product information block 132.

Systems 100 and 200 advantageously provide broadband activated micromarketing, merchandising and management tools with widespread applications for enhanced multimedia delivery. The systems facilitate delivery of personalized, targeted merchandising suggestions and ancillary content to users, whether in “real time,” “taped live,” or on-demand. A single individual may advantageously encode a multimedia communication with appropriate merchandising/ancillary content suggestions which are subsequently processed to provide more specific product/service/ancillary content to a viewer/user. While systems 100 and 200 have been described with reference to FIGS. 1 and 2 and the schematic elements and information flows depicted therein, the system/method of the present disclosure has far greater utility and application than those exemplary utilities and applications described herein, as will be readily apparent to persons skilled in the art after reading the present disclosure. The method/system of the present disclosure contemplates such diverse and varied utilities and applications and, accordingly, should not be limited the utilities and applications specifically disclosed herein.

What is claimed is:

1. A system for delivering content to a user; comprising:
a. encoder for receiving and encoding a multimedia file;
b. synchronization means in communication with said encoder, said synchronization means adapted to synchronize ancillary information with said multimedia file;
c. display unit for displaying said multimedia file; and
d. personalization means in communication with said display unit, said personalization means utilizing said ancillary information to select ancillary content for display by said display unit in synchronization with said multimedia file.

2. A system according to claim 1, wherein said multimedia file is selected from the group consisting of live, taped live and on-demand files.

3. A system according to claim 1, wherein said encoder encodes said multimedia file in advanced streaming format.

4. A system according to claim 1, wherein said encoder receives said multimedia file via satellite transmission.

5. A system according to claim 1, wherein said synchronization means utilizes timed interactive multimedia extension technology to synchronize said ancillary information with said multimedia file.

6. A system according to claim 1, wherein said ancillary information is selected from the group consisting of a category of goods, a category of services, background information concerning said multimedia file, and combinations thereof.

7. A system according to claim 1, wherein said synchronization means is associated with a computer system for input of said synchronized ancillary information.

8. A system according to claim 1, wherein said display unit includes a computer monitor communicating across a computer network to access said encoded multimedia file.

9. A system according to claim 1, wherein said personalization means includes a user database that contains user information concerning a user of said display unit.

10. A system according to claim 9, wherein said user information includes user preferences supplied to said user database by said user.

11. A system according to claim 1, wherein said personalization means includes a commerce database that contains said ancillary content.

12. A system according to claim 11, wherein said commerce database contains a plurality of ancillary content items associated with each of said ancillary information.

13. A system according to claim 1, further comprising an interactive list block that is displayed on said display unit and that permits a user to select ancillary content for subsequent attention.

14. A system according to claim 13, wherein said list block is adapted to function as a navigation bar by said user.

15. A method for facilitating targeted communication, comprising:
a. providing an encoded multimedia file that includes multimedia content and synchronized ancillary information;
b. selecting ancillary content from a commerce database based on said ancillary information for display with said multimedia content, said selection being based at least in part upon personal information concerning a recipient of said encoded multimedia file.

16. A method according to claim 15, wherein said synchronized ancillary information is associated with said multimedia content using timed interactive multimedia extension.

17. A method according to claim 15, wherein said selection is effectuated in real time.
